(19) United States
(12) Patent Application Publication
(10) Pub. No.: US 2022/0119260 A1
(43) Pub. Date: Apr. 21, 2022

(54) POROUS CARBON, CATALYST CARRIER, AND METHOD FOR PRODUCING POROUS CARBON

(71) Applicant: TOYOTA JIDOSHA KABUSHIKI KAISHA, Toyota-shi (JP)

(72) Inventors: Yunan WANG, Tokyo (JP); Rui IMOTO, Yokohama-shi (JP); Tomohiro OHNISHI, Sunto-gun (JP); Toshiyuki YOKOI, Yokohama-shi (JP)

(21) Appl. No.: 17/472,976

(22) Filed: Sep. 13, 2021

(30) Foreign Application Priority Data
Oct. 15, 2020 (JP) 2020-173872

(51) Int. Cl. C01B 32/05; B01J 21/18; B01J 35/10

(52) U.S. Cl. CPC C01B 32/05; B01J 21/18; B01J 35/1028; B01J 35/1061; C01P 2004/64; C01P 2006/14; C01P 2006/16; C01P 2006/12; B01J 35/1047

(57) ABSTRACT

Porous carbon is produced by a method in which a carbon source and a pore-forming agent are added to spherical silica serving as a template, the carbon source is then polymerized and carbonized, and finally the spherical silica serving as a template is removed.

### CROSS-REFERENCE TO RELATED APPLICATION

This application claims priority to Japanese Patent Application No. 2020-173872 filed on Oct. 15, 2020, incorporated herein by reference in its entirety.

### BACKGROUND

### 1. Technical Field

The present disclosure relates to porous carbon, a catalyst carrier, and a method for producing porous carbon.

### 2. Description of Related Art

There has been known a fuel cell in which an anode gas such as hydrogen is chemically reacted with a cathode gas such as oxygen to thereby generate electricity.

In such a fuel cell, an anode gas such as hydrogen (fuel gas) and a cathode gas such as oxygen (oxidant gas) are respectively supplied to two electrically connected electrodes, and the fuel is electrochemically oxidized, to thereby directly convert chemical energy into electrical energy.

Such a fuel cell is composed of a plurality of stacked unit cells each including, as a basic structure, a membrane-electrode assembly composed of an electrolyte membrane sandwiched between a pair of electrodes. In particular, a solid polyelectrolyte fuel cell including a solid polyelectrolyte membrane is expected to be used as a portable power source for mobile devices or a power source for vehicles (e.g., electric vehicles), since the fuel cell is advantageous in that, for example, it can be readily miniaturized and it operates at a low temperature.

The unit cell of such a solid polyelectrolyte fuel cell is known to be composed of, for example, a layered product in which an anode-side separator, an anode-side gas diffusion layer, an anode-side catalyst layer, an electrolyte membrane, a cathode-side catalyst layer, a cathode-side gas diffusion layer, and a cathode-side separator are disposed in this order.

In the solid polyelectrolyte fuel cell, the catalyst layer is generally composed of a mixture of an ionomer and an electrode catalyst including a catalyst carrier and fine particles of a catalyst metal (e.g., platinum) supported on the surface of the catalyst carrier. The catalyst carrier is made of a porous carbon material. The pore diameter, specific surface area, etc. of the porous carbon material are known to affect the properties of the fuel cell.

An attempt has been made to use mesoporous carbon having, for example, controlled pore diameter and specific surface area as the porous carbon material for forming such a catalyst carrier.

Japanese Unexamined Patent Application Publication No. 2010-265125 (JP 2010-265125 A) proposes a method in which a carbon source is added to a spherical mesoporous silica template, the carbon source is then carbonized, and subsequently the spherical mesoporous silica is removed, to thereby produce a spherical carbon porous product to which the structure of the spherical mesoporous silica is transferred.

Since the structure of the mesoporous silica is transferred to the porous carbon produced by the method of JP 2010-265125 A, the porous carbon can be provided with various shapes depending on the structure of the silica serving as a template. However, it is difficult to control the structure of the porous carbon while transferring the structure of the silica, the resultant porous carbon has a shape corresponding to the original shape of the template.

Japanese Unexamined Patent Application Publication (Translation of PCT Application) No. 2004-525846 (JP 2004-525846 A) discloses a technique for preparing spherical mesoporous silica serving as a template, in which an organic molecule such as TMB (1,3,5-trimethylbenzene) is used as a pore-forming agent for the purpose of controlling the pore size of the silica.

Although the technique of JP 2004-525846 A can control the structure of mesoporous silica serving as a template, the technique cannot control the structure of porous carbon while transferring the template thereto. Also, the technique encounters difficulty in controlling pores in the structure of spherical mesoporous silica serving as a template; for example, mesopores are less likely to be provided depending on the amount of TMB added.

### SUMMARY

An aspect of the present disclosure provides porous carbon that has a desired structure and desired physical properties and that is produced by controlling the structure of the carbon while transferring the structure of spherical silica serving as a template to the carbon. Another aspect of the present disclosure also provides a catalyst carrier, and a method for producing porous carbon.

The inventors have found that porous carbon having a desired structure and controlled physical properties can be produced by a method in which a carbon source and a pore-forming agent are added to spherical silica serving as a template, the carbon source is then polymerized and carbonized, and finally the spherical silica serving as a template is removed. The present disclosure has been accomplished on the basis of this finding. Accordingly, aspects of the present disclosure is as follows.

A first aspect of the present disclosure is directed to porous carbon having:

a BET specific surface area of 1,100 m²/g to 2,000 m²/g; and

a total pore volume V_{PT} of 1.0 m³/g to 10.0 m³/g, wherein:

a pore volume V_{P3˜6 nm} of pores having a pore diameter of 3 nm or more and 6 nm or less is 20% to 50% of the total pore volume V_{PT}; and

a pore volume V_{P6˜20 nm} pores having a pore diameter of more than 6 nm and 20 nm or less is 15% to 45% of the total pore volume V_{PT}.

The porous carbon may have an average pore diameter of 3 nm to 50 nm.

The porous carbon may have an average primary particle diameter of 30 nm to 200 nm.

A second aspect of the present disclosure is directed to a catalyst carrier containing the aforementioned porous carbon.

A third aspect of the present disclosure is directed to a method for producing porous carbon, the method including:

(a) preparing a raw material dispersion containing chain silica composed of chain-connected silica particles, a carbon source, and a pore-forming agent;

(b) polymerizing the carbon source in a presence of the pore-forming agent to form a carbon source polymer so as to provide the carbon source polymer and the pore-forming agent on a surface of the chain silica, to prepare a composite;

(c) firing the composite to carbonize the carbon source polymer and to remove the pore-forming agent, to prepare a composite carbide; and

(d) removing the chain silica from the composite carbide to produce porous carbon.

The silica particles may have an average particle diameter of 3 nm to 50 nm.

The chain silica may have an average length of 15 nm to 120 nm.

The carbon source may be furfuryl alcohol.

The pore-forming agent may be 1,3,5-trimethylbenzene.

When the porous carbon of the aspect of the present disclosure is produced, a carbon source and a pore-forming agent are added to spherical silica serving as a template. Thus, the porous carbon has mesopores to which the shape of the spherical silica is transferred, and the mesopores have a large size attributed to the pore-forming agent. Consequently, the porous carbon has a coralloid high-order structure.

Therefore, when, for example, the particle diameter of the spherical silica serving as a template and the amount of the pore-forming agent are regulated in accordance with the intended use of the porous carbon, the resultant porous carbon can exhibit controlled specific surface area, pore volume, and pore size distribution. Thus, the porous carbon can be suitably used in various applications.

In particular, the porous carbon of the aspect of the present disclosure has a high-order structure including size-distributed mesopores, and thus the porous carbon exhibits a large specific surface area and a large pore volume.

The porous carbon having a large specific surface area, a large total pore volume, and a specific amount of mesopores is very useful as a catalyst carrier for a fuel cell, and achieves formation of a catalyst layer exhibiting high catalyst reactivity and high material transportability. Thus, the use of the porous carbon of the aspect of the present disclosure as a catalyst carrier for a fuel cell can achieve an improvement in the properties of the fuel cell.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 shows a pore size distribution of pores having a pore diameter of 2 nm or more and 30 nm or less in porous carbons produced in Examples 1 to 3 and Comparative Example 1;

FIG. 2 shows a pore size distribution of pores having a pore diameter of 3 nm or more and 9 nm or less in the porous carbons produced in Examples 1 to 3 and Comparative Example 1;

FIG. 3 shows a pore size distribution of pores having a pore diameter of 7 nm or more and 21 nm or less in the porous carbons produced in Examples 1 to 3 and Comparative Example 1;

FIG. 4 is an image of the porous carbon produced in Example 1 as observed with a scanning electron microscope (SEM);

FIG. 5 is an image of the porous carbon produced in Example 1 as observed with a scanning electron microscope (SEM);

FIG. 6 is an image of the porous carbon produced in Example 2 as observed with a scanning electron microscope (SEM);

FIG. 7 is an image of the porous carbon produced in Example 3 as observed with a scanning electron microscope (SEM);

FIG. 8 is an image of the porous carbon produced in Comparative Example 1 as observed with a scanning electron microscope (SEM); and

FIG. 9 is an image of the porous carbon of Comparative Example 2 as observed with a scanning electron microscope (SEM).

### DETAILED DESCRIPTION OF EMBODIMENTS

Embodiments of the present disclosure will be described below in detail. The present disclosure is not limited to the following embodiments, and can be implemented in various modifications.

Porous Carbon

The porous carbon of an embodiment of the present disclosure has a large specific surface area, a large pore volume, and a specific amount of mesopores.

When the porous carbon of the present embodiment is produced, a carbon source and a pore-forming agent are added to spherical silica serving as a template. Thus, the porous carbon has mesopores to which the shape of the spherical silica is transferred, and the mesopores have a large size attributed to the pore-forming agent.

The porous carbon has a coralloid high-order structure including size-distributed mesopores.

As used herein, the term “mesopores” generally refers to pores having a pore diameter of 2 nm to 50 nm. Among the mesopores of the porous carbon, mesopores having a pore diameter of 2 nm to 6 nm contribute to an increase in the specific surface area of the porous carbon. Thus, when the porous carbon is used as, for example, a catalyst carrier for a fuel cell, the mesopores having a pore diameter of 2 nm to 6 nm contribute to an increase in the percentage of fine particles of a catalyst metal (e.g., platinum) supported on the surface of the carrier, and an improvement in supporting uniformity. Therefore, such mesopores in the porous carbon play roles in imparting high electrical conductivity to a catalyst layer of the fuel cell and in promoting a catalyst reaction.

When the porous carbon is used as, for example, a gas diffusion layer for a fuel cell, the mesopores having a pore diameter of 2 nm to 6 nm contribute to an improvement in gas diffusibility and play a roll in improving the performance of the fuel cell.

Meanwhile, when the porous carbon is used as, for example, a catalyst carrier for a fuel cell, mesopores having a pore diameter of 6 nm to 20 nm in the porous carbon contribute to an improvement in material mobility outside of the carrier. Thus, such mesopores in the porous carbon play a role in increasing the output of the fuel cell.

Therefore, the porous carbon having the aforementioned two types of mesopores, a large specific surface area, and a large total pore volume is very useful as a catalyst carrier for a fuel cell.

BET Specific Surface Area

The porous carbon of the present embodiment has a BET specific surface area of 1,100 m²/g to 2,000 m²/g.

When the BET specific surface area is 1,100 m²/g to 2,000 m²/g, the porous carbon can be used in various applications. In particular, when the porous carbon is used as a catalyst carrier for a fuel cell, favorable catalyst performance is achieved.

When the BET specific surface area is less than 1,100 m²/g, the use of the porous carbon as a catalyst carrier for a fuel cell leads to a reduction in catalyst activity. Meanwhile, when the BET specific surface area is more than 2,000 m²/g, difficulty is encountered in increasing the percentage of micropores in the porous carbon.

The BET specific surface area can be adjusted by controlling, for example, the particle diameter of spherical silica serving as a template and the amount of a pore-forming agent in the below-described production method for porous carbon.

The BET specific surface area may be 1,150 m²/g or more, 1,200 m²/g or more, 1,300 m²/g or more, 1,400 m²/g or more, 1,500 m²/g or more, 1,600 m²/g or more, 1,700 m²/g or more, 1,800 m²/g or more, or 1,900 m²/g or more. The BET specific surface area can be appropriately determined in accordance with the intended use of the porous carbon.

The BET specific surface area may be 1,900 m²/g or less, 1,800 m²/g or less, 1,700 m²/g or less, 1,600 m²/g or less, 1,500 m²/g or less, 1,400 m²/g or less, 1,300 m²/g or less, 1,200 m²/g or less, or 1,150 m²/g or less. The BET specific surface area can be appropriately determined in accordance with the intended use of the porous carbon.

Total Pore Volume V_{PT}

The porous carbon of the present embodiment has a total pore volume V_{PT} of 1.0 m³/g to 10.0 m³/g as determined by the BJH (Barrett, Joyner, Hallender) method. As used in the present specification, “pores” included in the total pore volume V_{PT} correspond to pores having a pore diameter of 2 nm or more and 200 nm or less.

When the total pore volume V_{PT} is 1.0 m³/g to 10.0 m³/g, the porous carbon can be used in various applications. In particular, when the porous carbon is used as a catalyst carrier for a fuel cell, favorable catalyst performance is achieved.

When the total pore volume V_{PT} is less than 1.0 m³/g, the use of the porous carbon as a catalyst carrier for a fuel cell leads to a reduction in catalyst activity. Meanwhile, when the total pore volume V_{PT} is more than 10.0 m³/g, difficulty is encountered in increasing the percentage of mesopores in the porous carbon.

The total pore volume V_{PT} can be adjusted by controlling, for example, the particle diameter of spherical silica serving as a template and the amount of a pore-forming agent in the below-described production method for porous carbon.

The total pore volume V_{PT} may be 1.3 m³/g or more, 2.0 m³/g or more, 3.0 m³/g or more, 4.0 m³/g or more, 5.0 m³/g or more, 6.0 m³/g or more, 7.0 m³/g or more, 8.0 m³/g or more, or 9.0 m³/g or more. The total pore volume V_{PT} can be appropriately determined in accordance with the intended use of the porous carbon.

The total pore volume V_{PT} may be 9.0 m³/g or less, 8.0 m³/g or less, 7.0 m³/g or less, 6.0 m³/g or less, 5.0 m³/g or less, 4.0 m³/g or less, 3.0 m³/g or less, 2.0 m³/g or less, or 1.3 m³/g or less. The total pore volume V_{PT} can be appropriately determined in accordance with the intended use of the porous carbon.

Pore Volume V_{P3˜6 nm} of Pores Having Pore Diameter of 3 nm or more and 6 nm or less

In the porous carbon of the present embodiment, the pore volume V_{P3˜6 nm} of pores having a pore diameter of 3 nm or more and 6 nm or less, which is determined by the BJH (Barrett, Joyner, Hallender) method, is 20% to 50% of the total pore volume V_{PT}.

When the pore volume V_{P3˜6 nm} of pores having a pore diameter of 3 nm or more and 6 nm or less is 20% to 50% of the total pore volume V_{PT}, the porous carbon can be used in various applications. In particular, when the porous carbon is used as a catalyst carrier for a fuel cell, favorable catalyst performance is achieved.

When the pore volume V_{P3˜6 nm} of pores having a pore diameter of 3 nm or more and 6 nm or less is less than 20% of the total pore volume V_{PT}, the use of the porous carbon as a catalyst carrier for a fuel cell leads to a reduction in catalyst activity. Meanwhile, when the pore volume V_{P3˜6 nm} of pores having a pore diameter of 3 nm or more and 6 nm or less is more than 50% of the total pore volume V_{PT}, difficulty is encountered in increasing the percentage of large-sized mesopores in the porous carbon. Thus, when the porous carbon is used as a catalyst carrier for a fuel cell, the porous carbon is less likely to contribute to an improvement in material mobility outside of the carrier.

The pore volume V_{P3˜6 nm} of pores having a pore diameter of 3 nm or more and 6 nm or less can be adjusted by controlling, for example, the particle diameter of spherical silica serving as a template in the below-described production method for porous carbon.

The pore volume V_{P3˜6 nm} of pores having a pore diameter of 3 nm or more and 6 nm or less may be 25% or more, 30% or more, 35% or more, 40% or more, or 45% or more. The pore volume V_{P3˜6 nm} can be appropriately determined in accordance with the intended use of the porous carbon.

The pore volume V_{P3˜6 nm} of pores having a pore diameter of 3 nm or more and 6 nm or less may be 45% or less, 40% or less, 35% or less, 30% or less, or 20% or less. The pore volume V_{P3˜6 nm} can be appropriately determined in accordance with the intended use of the porous carbon.

Pore Volume V_{P6˜20 nm} of Pores Having Pore Diameter of more than 6 nm and 20 nm or less

In the porous carbon of the present embodiment, the pore volume V_{P6˜20 nm} of pores having a pore diameter of more than 6 nm and 20 nm or less, which is determined by the BJH (Barrett, Joyner, Hallender) method, is 15% to 45% of the total pore volume V_{PT}.

When the pore volume V_{P6˜20 nm} of pores having a pore diameter of more than 6 nm and 20 nm or less is 15% to 45% of the total pore volume V_{PT}, the porous carbon can be used in various applications. In particular, when the porous carbon is used as a catalyst carrier for a fuel cell, the porous carbon can contribute to an improvement in material mobility outside of the carrier.

When the pore volume V_{P6˜20 nm} of pores having a pore diameter of more than 6 nm and 20 nm or less is less than 15% of the total pore volume V_{PT}, the use of the porous carbon as a catalyst carrier for a fuel cell leads to difficulty in improving material mobility outside of the carrier. Meanwhile, when the pore volume V_{P6˜20 nm} of pores having a pore diameter of more than 6 nm and 20 nm or less is more than 45% of the total pore volume V_{PT}, difficulty is encountered in increasing the percentage of small-sized mesopores in the porous carbon.

The pore volume V_{P6˜20 nm} of pores having a pore diameter of more than 6 nm and 20 nm or less can be adjusted by controlling, for example, the amount of a pore-forming agent used in the below-described production method for porous carbon.

The pore volume V_{P6˜20 nm} of pores having a pore diameter of more than 6 nm and 20 nm or less may be 18% or more, 20% or more, 25% or more, 30% or more, or 35% or more. The pore volume V_{P6˜20 nm} can be appropriately determined in accordance with the intended use of the porous carbon.

The pore volume V_{P6˜20 nm} of pores having a pore diameter of more than 6 nm and 20 nm or less may be 40% or less, 35% or less, 30% or less, 25% or less, 20% or less, or 15% or less. The pore volume V_{P6˜20 nm} can be appropriately determined in accordance with the intended use of the porous carbon.

Average Pore Diameter

The porous carbon of the present embodiment has an average pore diameter of 3 nm to 50 nm as determined by the BJH (Barrett, Joyner, Hallender) method.

When the average pore diameter is 3 nm to 50 nm, the porous carbon can be used in various applications. In particular, when the porous carbon is used as a catalyst carrier for a fuel cell, favorable catalyst performance is achieved.

When the average pore diameter is less than 3 nm, the use of the porous carbon as a catalyst carrier for a fuel cell leads to a reduction in catalyst activity. Meanwhile, when the average pore diameter is more than 50 nm, difficulty is encountered in increasing the percentage of mesopores in the porous carbon.

The average pore diameter can be adjusted by controlling, for example, the particle diameter of spherical silica serving as a template and the amount of a pore-forming agent in the below-described production method for porous carbon.

The average pore diameter may be 4 nm or more, 5 nm or more, 6 nm or more, 8 nm or more, 10 nm or more, 20 nm or more, 30 nm or more, or 40 nm or more. The average pore diameter can be appropriately determined in accordance with the intended use of the porous carbon.

The average pore diameter may be 40 nm or less, 30 nm or less, 20 nm or less, 10 nm or less, 8 nm or less, 6 nm or less, 5 nm or less, or 4 nm or less. The average pore diameter can be appropriately determined in accordance with the intended use of the porous carbon.

Average Primary Particle Diameter

The porous carbon of the present embodiment has an average primary particle diameter of 30 nm to 200 nm. The term “average primary particle diameter” as used herein refers to a numerical average calculated as follows: at least 200 primary particles of porous carbon are observed with a scanning electron microscope (SEM), the equivalent circle diameter of a perfect circle having an area equal to that of each observed primary particle is determined, and the thus-determined equivalent circle diameters are averaged, i.e., divided by the total number of the primary particles.

When the average primary particle diameter is 30 nm to 200 nm, the porous carbon can be used in various applications. In particular, when the porous carbon is used as a catalyst carrier for a fuel cell, favorable catalyst performance is achieved.

When the average primary particle diameter is less than 30 nm, the porous carbon is difficult to handle. Meanwhile, when the average primary particle diameter is more than 200 nm, the porous carbon exhibits lowered specific surface area. In such a case, when the porous carbon is used as, for example, a catalyst carrier for a fuel cell, the active sites of the catalyst are reduced.

The average primary particle diameter can be adjusted by controlling, for example, the amount of a pore-forming agent in the below-described production method for porous carbon. An increase in the amount of a pore-forming agent used tends to lead to a reduction in the average primary particle diameter of the resultant porous carbon.

The average primary particle diameter may be 35 nm or more, 40 nm or more, 50 nm or more, 60 nm or more, 70 nm or more, 80 nm or more, 90 nm or more, or 100 nm or more. The average primary particle diameter can be appropriately determined in accordance with the intended use of the porous carbon.

The average primary particle diameter may be 190 nm or less, 180 nm or less, 170 nm or less, 160 nm or less, 150 nm or less, 140 nm or less, 130 nm or less, or 120 nm or less. The average primary particle diameter can be appropriately determined in accordance with the intended use of the porous carbon.

Application of Porous Carbon

No particular limitation is imposed on the application of the porous carbon of the present embodiment. Since the specific surface area, pore volume, and pore size distribution of the porous carbon can be controlled, the porous carbon can be suitably used in various applications.

In particular, the porous carbon of the present embodiment, which has a large specific surface area, a large total pore volume, and a specific amount of mesopores, is very useful as a catalyst carrier for a fuel cell. When the porous carbon of the present embodiment is used as a catalyst carrier for a fuel cell, the resultant catalyst layer exhibits high catalyst reactivity and high material transportability. Thus, the properties of the fuel cell can be improved.

Production Method for Porous Carbon

The following production method for porous carbon of the present embodiment is an example to produce the aforementioned porous carbon of the present embodiment. The production method for porous carbon of the present embodiment includes steps (a) to (d) as described below. In the production method, a carbon source and a pore-forming agent are added to spherical silica serving as a template, the carbon source are then polymerized and carbonized, and finally the spherical silica serving as a template is removed.

The production method for porous carbon of the present embodiment involves the use of chain silica as a template, and can produce porous carbon to which the shape of the chain silica is transferred.

In particular, the production method for porous carbon of the present embodiment involves the addition of a pore-forming agent together with a carbon source to spherical silica serving as a template. Thus, the method can produce porous carbon having mesopores to which the shape of the spherical silica is transferred, large-sized mesopores attributed to the pore-forming agent, and a coralloid high-order structure.

According to the present embodiment, the specific surface area, pore volume, and pore size distribution of the resultant porous carbon can be controlled by controlling the particle size of the spherical silica serving as a template and the amount of the pore-forming agent. Consequently, the porous carbon can exhibit physical properties suitable for various applications.

In particular, the porous carbon produced by the production method for porous carbon of the present embodiment has a coralloid high-order structure including size-distributed mesopores. Thus, the porous carbon has a large specific surface area and a large pore volume.

Step (a)

Step (a) involves preparing a raw material dispersion containing chain silica composed of chain-connected silica particles, a carbon source, and a pore-forming agent. The raw material dispersion may optionally contain an additional component such as a solvent or an additive.

Chain Silica

The chain silica serving as a template has a structure composed of connected silica particles. No particular limitation is imposed on the production method for the chain silica. For example, the chain silica can be produced by calcining a self-organized chain body prepared by the method described in J. Am. Chem. Soc., 2009, 131: 16344.

Specifically, a block copolymer is added to a dispersion containing dispersed silica particles to provide the block copolymer around the silica particles, and the pH of the dispersion is adjusted to promote self-organization attributed to the block copolymer, whereby the silica particles are connected in a chain form.

The chain silica serving as a template and used in the present embodiment can be produced by calcining a composite made up of the block copolymer and the silica particles that are chain-connected through self-organization of the block copolymer.

The silica particles serving as a raw material of the chain silica may have an average particle diameter of 3 nm to 50 nm. The chain silica may have an average length of 15 nm to 120 nm.

The surface of the chain silica serving as a template is provided with the carbon source polymer, and the shape of the chain silica is transferred to the finally produced porous carbon. Thus, the particle diameter and chain length of the chain silica are transferred in the form of mesopores (2 nm to 50 nm) to the resultant porous carbon.

Thus, in the production method for porous carbon of the present embodiment, the average particle diameter of silica particles used as a raw material of the chain silica or the average length of the chain silica can be appropriately determined depending on the physical properties required for the porous carbon.

The average particle diameter of the silica particles for forming the chain silica may be 5 nm or more, 7 nm or more, 10 nm or more, 15 nm or more, 20 nm or more, 25 nm or more, or 30 nm or more, and may be 45 nm or less, 40 nm or less, 35 nm or less, 30 nm or less, 25 nm or less, or 20 nm or less.

The average length of the chain silica may be 20 nm or more, 25 nm or more, 30 nm or more, 35 nm or more, 40 nm or more, or 50 nm or more, and may be 115 nm or less, 110 nm or less, 105 nm or less, 100 nm or less, 95 nm or less, 90 nm or less, 85 nm or less, 80 nm or less, 75 nm or less, or 70 nm or less.

The term “average particle diameter” as used herein refers to a numerical average calculated as follows: at least 200 silica particles are observed with a scanning electron microscope (SEM), the equivalent circle diameter of a perfect circle having an area equal to that of each observed particle is determined, and the thus-determined equivalent circle diameters are averaged, i.e., is divided by the total number of the particles.

The term “average length” as used herein refers to a numerical average calculated from the long-axis lengths of at least 200 particles of chain silica as observed with a scanning electron microscope (SEM).

Carbon Source

No particular limitation is imposed on the carbon source used in the production method for porous carbon of the present embodiment, so long as the carbon source forms a polymer covering the surface of the aforementioned chain silica through polymerization, and then is carbonized into porous carbon through firing.

The carbon source is preferably, for example, any alcohol, since the chain silica is dispersed in the alcohol, and the alcohol itself is deposited on the surface of the chain silica through polymerization to thereby cover the chain silica.

In particular, the carbon source is preferably furfuryl alcohol, since a furan resin suitable as a carbon material resin is prepared through polymerization.

Pore-Forming Agent

The pore-forming agent used in the production method for porous carbon of the present embodiment covers the surface of the chain silica together with the aforementioned carbon source polymer, and then is removed through firing. The use of the pore-forming agent can form mesopores having a pore size distribution including a large size in the resultant porous carbon, and thus the porous carbon can have a coralloid high-order structure.

Without wishing to be bound by theory, the reason why the pore-forming agent can form pores having a wide-range pore size distribution is probably attributed to that the compatibility between the pore-forming agent and the carbon source is higher than that between the pore-forming agent and the chain silica.

No particular limitation is imposed on the pore-forming agent used in the production method for porous carbon of the present embodiment, so long as the pore-forming agent has high compatibility with the carbon source that is simultaneously incorporated. In particular, the pore-forming agent is preferably 1,3,5-trimethylbenzene, since it is easy to handle and readily available.

The concentration of the pore-forming agent in the prepared raw material dispersion can be appropriately adjusted depending on the physical properties required for the porous carbon. When the concentration of the pore-forming agent is increased, the percentage of mesopores having a large diameter can be increased in the resultant porous carbon.

Step (b)

Step (b) involves polymerizing the carbon source in the presence of the pore-forming agent so as to provide a carbon source polymer and the pore-forming agent on the surface of the chain silica, to thereby prepare a composite.

No particular limitation is imposed on the conditions for the polymerization, and the conditions can be appropriately determined depending on the type of the carbon source used and the amount of the carbon source added.

Step (c)

Step (c) involves firing the composite prepared in step (b) to carbonize the carbon source polymer and to remove the pore-forming agent, to thereby prepare a composite carbide.

No particular limitation is imposed on the method and conditions for the firing, so long as the carbon source polymer in the composite can be carbonized, and the pore-forming agent can be removed.

Step (d)

Step (d) involves removing the chain silica from the composite carbide prepared in step (c) to thereby produce porous carbon. Specifically, the chain silica serving as a template is removed from the composite carbide, to thereby produce porous carbon to which the shape of the chain silica is transferred.

No particular limitation is imposed on the method for removing the chain silica. For example, the chain silica is removed by a method involving eluting the chain silica from the composite carbide with, for example, a solvent capable of dissolving silica.

After removal of the silica, the porous carbon may optionally be subjected to an additional post-process, such as further washing or drying.

The present embodiment will next be described in more detail with reference to, for example, experimental results.

### Examples 1 to 3 and Comparative Example 1

Step (a)

Chain silica having an average length shown in Table 1 and composed of silica particles having a particle size shown in Table 1 was provided, and the chain silica was used as a template.

To the chain silica were added furfuryl alcohol (FA) serving as a carbon source and 1,3,5-trimethylbenzene (TMB) serving as a pore-forming agent so as to achieve a volume ratio shown in Table 1, to thereby prepare a raw material dispersion.

TABLE 1

| | | | | | Comparative | Comparative |
|---|---|---|---|---|---|---|
| | | Example 1 | Example 2 | Example 3 | Example 1 | Example 2 |
| Average particle diameter of silica | (nm) | 6 | 6 | 6 | 6 | — |
| particles | | | | | | |
| Average length of chain silica | (nm) | 30-60 | 30-60 | 30-60 | 30-60 | — |
| FA:TMB | (Volume ratio) | 100:200 | 100:100 | 100:50 | 100:0 | — |
| BET specific surface area | (m²/g) | 1743 | 1416 | 1235 | 1170 | 941 |
| Total pore volume V_{PT} | (m³/g) | 4.20 | 2.30 | 1.30 | 1.25 | 0.89 |
| Pore volume V_{P3~6 nm} | (m³/g) | 0.89 | 0.75 | 0.58 | 0.63 | 0.29 |
| Percentage of pore volume V_{P3~6 nm} to | (%) | 21.19 | 32.61 | 44.62 | 50.40 | 32.58 |
| total pore volume V_{PT} | | | | | | |
| Pore volume V_{P6~20 nm} | (m³/g) | 1.69 | 0.59 | 0.21 | 0.18 | 0.11 |
| Percentage of pore volume V_{P6~20 nm} to | (%) | 40.24 | 25.65 | 16.15 | 14.40 | 12.36 |
| total pore volume V_{PT} | | | | | | |
| Average pore diameter | (nm) | 6.00 | 6.00 | 6.19 | 5.82 | 1.80 |
| Average primary particle diameter | (nm) | 50-100 | 50-150 | 50-1000 | 800-1000 | 100-150 |

| | | | | | |
|---|---|---|---|---|---|
| Carbon structure | Coralloid | Coralloid | Coralloid | Massive | Arboroid |

Step (b)

The prepared raw material dispersion was subjected to polymerization at 60° C. for 16 hours. Subsequently, the resultant product was heated to 80° C. and subjected to polymerization for 16 hours, to thereby yield a composite containing the chain silica having a surface provided with a furan resin and 1,3,5-trimethylbenzene (TMB).

Step (c)

The composite containing the chain silica having a surface provided with the furan resin and TMB was calcined at 800° C. for one hour to carbonize the furan resin and to remove TMB, to thereby yield a composite carbide.

Step (d)

The composite carbide was treated with hydrogen fluoride to remove the chain silica from the composite carbide, to thereby produce porous carbon.

Evaluation of Porous Carbon

The porous carbon produced in each of Examples 1 to 3 and Comparative Example 1 was evaluated for the following properties. The results are shown in Table 1.

BET Specific Surface Area

The BET specific surface area was measured by the BJH (Barrett, Joyner, Hallender) method. Specifically, 50 mg of the porous carbon was placed in a gas adsorption amount measuring apparatus (BELSORPMAXII, available from MicrotracBEL Corp.), the apparatus was degassed under heating at 350° C. for one hour, and then nitrogen adsorption was performed at −196° C.

Total Pore Volume V_{PT}

The total pore volume V_{PT} (pore diameter: 2 nm or more and 200 nm or less) was measured by the BJH (Barrett, Joyner, Hallender) method simultaneously with the aforementioned measurement of BET specific surface area.

Volume of Pores Having Pore Diameter of 3 nm or more and 6 nm or less (V_{P3˜6 nm})

The pore volume V_{P3˜6 nm} of pores having a pore diameter of 3 nm or more and 6 nm or less was analyzed by the BJH (Barrett, Joyner, Hallender) method simultaneously with the aforementioned measurement of BET specific surface area.

Percentage of Pore Volume V_{P3˜6 nm} of Pores Having Pore Diameter of 3 nm or more and 6 nm or less to Total Pore Volume V_{PT}

The percentage (%) of the pore volume V_{P3˜6 nm} of pores having a pore diameter of 3 nm or more and 6 nm or less to the total pore volume V_{PT} was calculated. Pore Volume V_{P6˜20 nm} of Pores Having Pore Diameter of more than 6 nm and 20 nm or less

The pore volume V_{P6˜20 nm} of pores having a pore diameter of more than 6 nm and 20 nm or less was analyzed by the BJH (Barrett, Joyner, Hallender) method simultaneously with the aforementioned measurement of BET specific surface area.

Percentage of Pore Volume V_{P6˜20 nm} of Pores Having Pore Diameter of more than 6 nm and 20 nm or less to Total Pore Volume V_{PT}

The percentage (%) of the pore volume V_{P6˜20 nm} of pores having a pore diameter of more than 6 nm and 20 nm or less to the total pore volume V_{PT} was calculated.

Average Pore Diameter

The average pore diameter of pores having a pore diameter of 2 nm or more and 200 nm or less was determined from a pore size distribution obtained by the BJH (Barrett, Joyner, Hallender) method simultaneously with the aforementioned measurement of BET specific surface area.

Pore Size Distribution

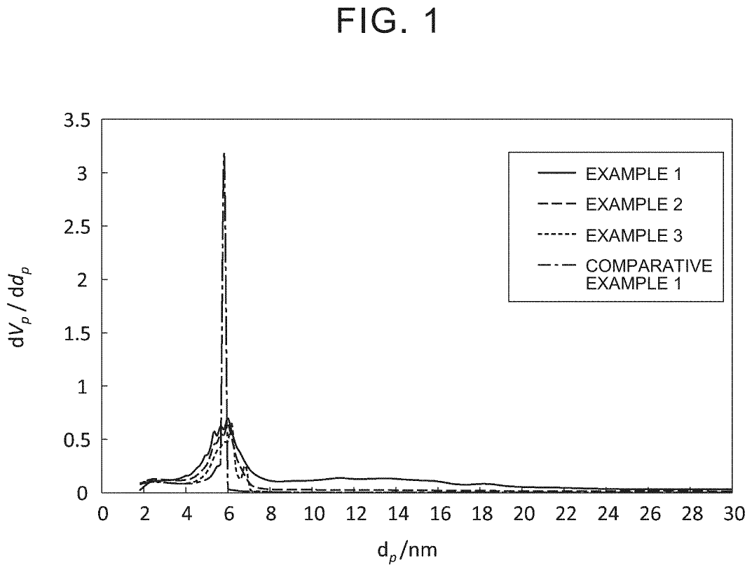

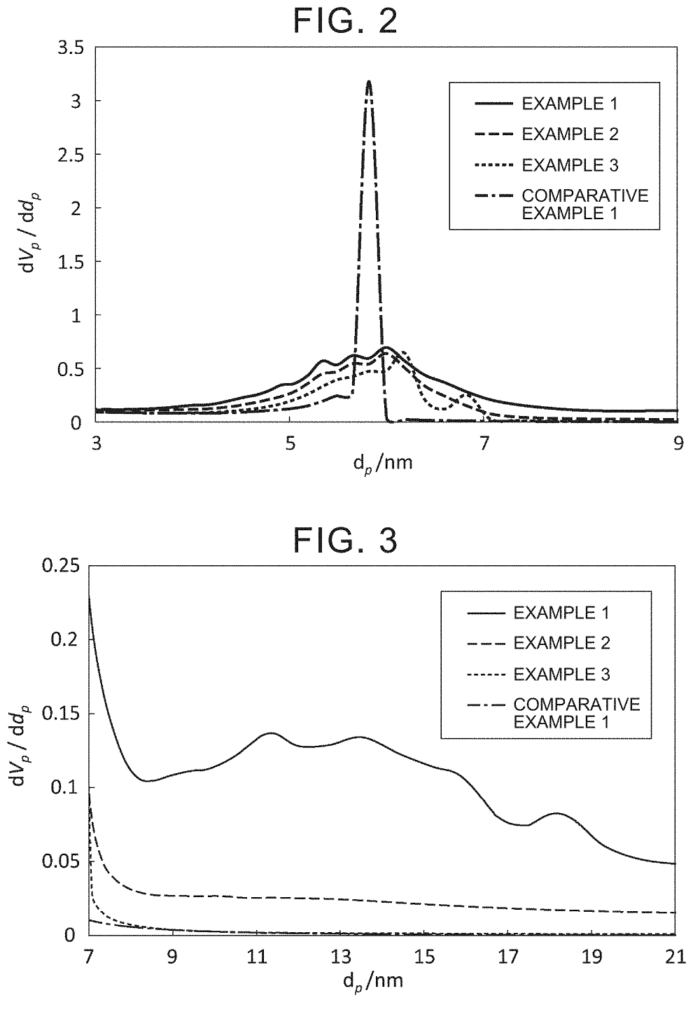

A pore size distribution diagram was prepared based on data obtained by the BJH (Barrett, Joyner, Hallender) method simultaneously with the aforementioned measurement of BET specific surface area. FIG. 1 shows the pore size distribution of pores having a pore diameter of 2 nm to 30 nm; FIG. 2 shows the pore size distribution of pores having a pore diameter of 3 nm to 9 nm; and FIG. 3 shows the pore size distribution of pores having a pore diameter of 7 nm to 21 nm.

Average Primary Particle Diameter

The porous carbon was observed with a scanning electron microscope (SEM) (SU9000, available from Hitachi High-Tech Corporation) at a magnification of 20,000, and 200 primary particles of the porous carbon were selected in the resultant image. The equivalent circle diameter of a perfect circle having an area equal to that of each primary particle was determined, and the average of the thus-determined equivalent circle diameters was calculated

Observation with Electron Microscope

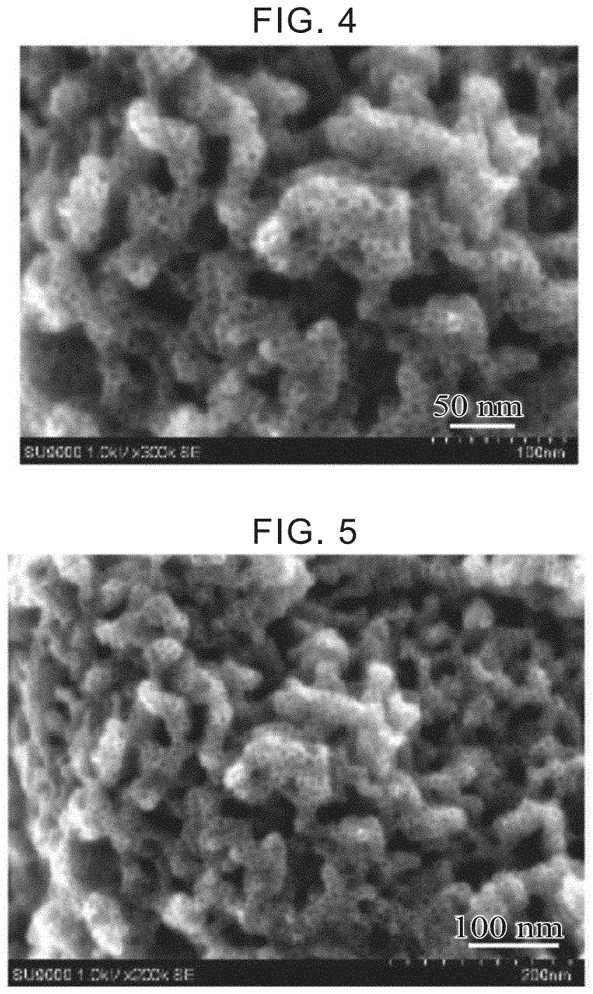

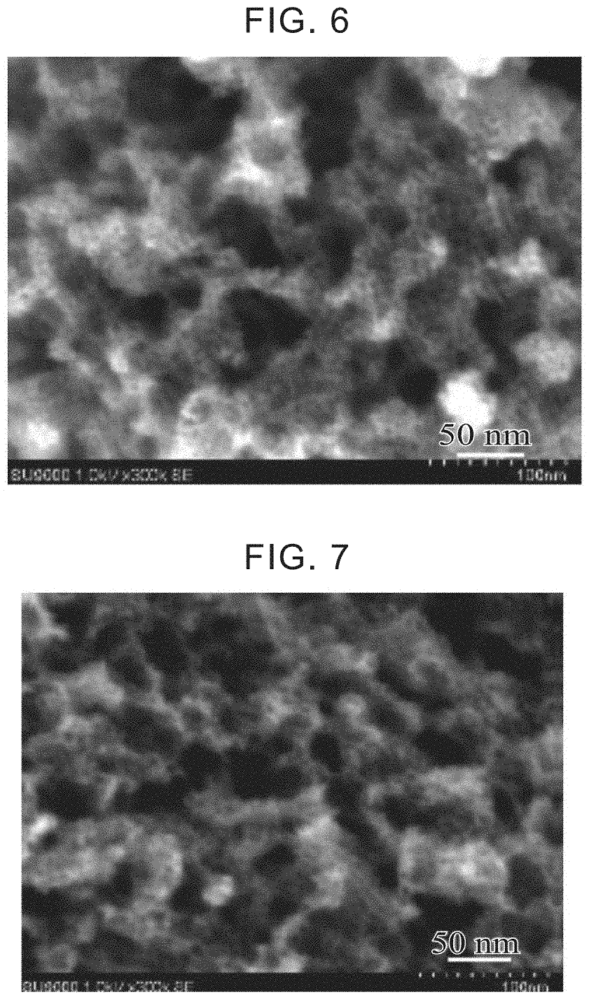

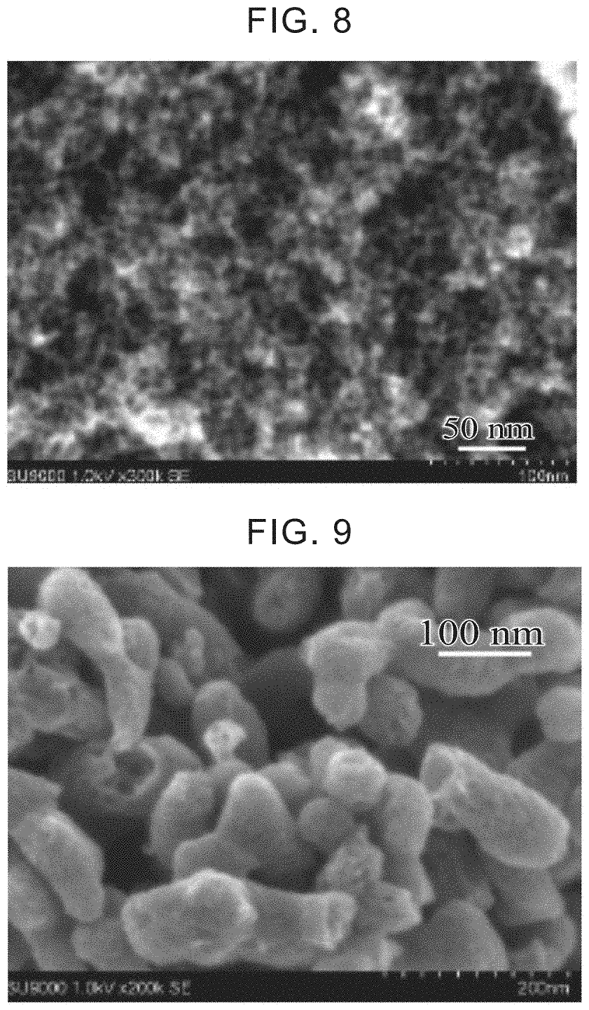

The produced porous carbons were observed with a scanning electron microscope (SEM) (SU9000, available from Hitachi High-Tech Corporation). FIGS. 4 and 5 show images of the porous carbon produced in Example 1; FIG. 6 shows an image of the porous carbon produced in Example 2; FIG. 7 shows an image of the porous carbon produced in Example 3; and FIG. 8 shows an image of the porous carbon produced in Comparative Example 1.

### Comparative Example 2

Commercially available ESCARBON (trade name: ESCARBON (registered trademark)-MCND, available from NIPPON STEEL Chemical & Material Co., Ltd.) was provided and evaluated in the same manner as described above. The results are shown in Table 1. FIG. 9 shows an image of the commercially available product as observed with an electron microscope.

What is claimed is:

1. Porous carbon having:
a BET specific surface area of 1,100 m²/g to 2,000 m²/g; and
a total pore volume V_{PT} of 1.0 m³/g to 10.0 m³/g, wherein:
a pore volume V_{P3˜6 nm} of pores having a pore diameter of 3 nm or more and 6 nm or less is 20% to 50% of the total pore volume V_{PT}; and
a pore volume V_{P6˜20 nm} of pores having a pore diameter of more than 6 nm and 20 nm or less is 15% to 45% of the total pore volume V_{PT}.

2. The porous carbon according to claim 1, wherein the porous carbon has an average pore diameter of 3 nm to 50 nm.

3. The porous carbon according to claim 1, wherein the porous carbon has an average primary particle diameter of 30 nm to 200 nm.

4. A catalyst carrier comprising the porous carbon according to claim 1.

5. A method for producing porous carbon, the method comprising:
(a) preparing a raw material dispersion containing chain silica composed of chain-connected silica particles, a carbon source, and a pore-forming agent;
(b) polymerizing the carbon source in a presence of the pore-forming agent to form a carbon source polymer so as to provide the carbon source polymer and the pore-forming agent on a surface of the chain silica, to prepare a composite;
(c) firing the composite to carbonize the carbon source polymer and to remove the pore-forming agent, to prepare a composite carbide; and
(d) removing the chain silica from the composite carbide to produce porous carbon.

6. The method according to claim 5, wherein the silica particles have an average particle diameter of 3 nm to 50 nm.

7. The method according to claim 5, wherein the chain silica has an average length of 15 nm to 120 nm.

8. The method according to claim 5, wherein the carbon source is furfuryl alcohol.

9. The method according to claim 5, wherein the pore-forming agent is 1,3,5-trimethylbenzene.
